(19) United States
(12) Patent Application Publication
(10) Pub. No.: US 2012/0278258 A1
(43) Pub. Date: Nov. 1, 2012

(54) MEANS AND METHOD OF INVESTMENT PORTFOLIO MANAGEMENT

(76) Inventor: Amir Ayal, Herzelia Pituach (IL)

(21) Appl. No.: 13/519,033

(22) PCT Filed: Dec. 23, 2010
(86) PCT No.: PCT/IL10/01080

§ 371 Date: Jul. 18, 2012

Related U.S. Application Data
(60) Provisional application No. 61/290,020, filed on Dec. 24, 2009.

(51) Int. Cl. G06Q 40/06

(52) U.S. Cl. 705/36 R

(57) ABSTRACT

The core of the present invention is to provide means and methods for managing an investment portfolio according to an investor's personal financial risk tolerance. In one embodiment this is accomplished by means of two separate and independently managed portfolios, these being a high-risk portfolio and low-risk portfolio, with an appropriate ratio of investment in each as appropriate for a given investor's risk tolerance. In another embodiment this is accomplished by choosing an investment portfolio that optimizes certain metrics related to ROI and the given investor's risk tolerance.

### FIELD OF THE INVENTION

The present invention generally relates to means and methods for managing an investment portfolio management according to an investor's personal financial risk tolerance or anxiety level.

### BACKGROUND OF THE INVENTION

U.S. Pat. No. 5,101,353 to Lupien et al. discloses an apparatus and a method for broadly increasing liquidity and depth in such markets by trading portions of normally dormant portfolios including those with numerous and diverse securities. The invention seeks to accomplish this without substantially increasing the risk of loss to holders of those portfolios by maintaining an approximation of the desired investment mix in those portfolios while reacting to market pressures so as to generate incremental returns to portfolio holders. This patent is concerned about the liquidity of a portfolio, and is not aimed at reducing the investor's anxiety by separately managing high risk and low risk portfolios.

U.S. Pat. No. 7,509,274 to Kam et al. discloses a system of attracting and identifying the best investors, including offering and managing performance-based investment competitions based on model investment portfolios, creating actual portfolios for the identified best investor, creating and operating actual mutual funds based on the identified best investors as fund managers, and providing a full suite of related subscriber and investor services associated therewith as a fund supermarket. This patent is concerned about creation of general portfolios, without dealing with the risk factor, and is not aimed at reducing the investor's anxiety by separately managing high risk and low risk portfolios.

U.S. Pat. No. 7,110,971 to Wallman discloses a method and apparatus for electronically trading over wired and wireless networks, including over the Internet, and investing in securities or other assets, rights or liabilities that enables a user, at a reasonable cost, to create and manage a complex and diversified portfolio of such securities or other assets, rights or liabilities. This patent discloses an electronically trading apparatus, and is not aimed at reducing the investor's anxiety by separately managing high risk and low risk portfolios.

U.S. Pat. No. 7,373,324 Engin et al. discloses a computer system for facilitating the distribution of financial investment advice. This patent is not aimed at reducing the investor's anxiety by separately managing high risk and low risk portfolios.

U.S. Pat. No. 7,120,601 to Chen et al. discloses a method and system for allocating retirement savings to finance retirement consumption. More particularly, the present invention relates to a method and system for optimally allocating investment assets within and between annuitized assets and non-annuitized assets having different degrees of risk and return. This patent is not aimed at reducing the investor's anxiety by separately managing high risk and low risk portfolios.

U.S. Pat. No. 7,430,532 to Wizon et al. discloses a system and method for effectuating a transaction involving financial instruments such as fixed income securities, and more particularly, to a system and method for conducting a risk analysis on a fixed income security and subsequently initiating a trade of that security. This patent is not aimed at, reducing the investor's anxiety by separately managing high risk and low risk portfolios

U.S. Pat. No. 6,859,788 to Davey discloses an automated system and method for the assessment of an individual's attitude towards financial risk. This patent is not aimed at reducing the investor's anxiety by separately managing high risk and low risk portfolios Risk is involved where a choice has to be made, and there is uncertainty about the outcome of at least one of the alternatives. Risk tolerance is the level of risk with which an individual is comfortable. As such, it is a personal attribute. In relation to an individual's attitude towards financial risk, it is desirable from many points of view to make an assessment of risk tolerance.

Studies confirm that people generally do not accurately estimate their own risk tolerance (and, not surprisingly, given the difficulties in any communication about an intangible, their financial advisors' estimates are less accurate than their own). While the findings are scattered, there is a slight overall tendency to over-estimate risk tolerance. A possible explanation for this is that the majority of the population is, in absolute terms, more risk-avoiding than it is risk-seeking. Faced with a choice between a certain profit and an uncertain, but probably larger profit, a sizeable majority chooses the certain (but probably smaller) profit. Someone, who in absolute terms is slightly risk-averse, may not realize that this is typical of the population as a whole.

An assessment of individuals' Personal Financial Risk Tolerance (PFRT) provides knowledge that may assist in making appropriate decisions concerning said individual's financial position. These decisions will be ‘appropriate’ in the sense that they involve a level of risk in keeping with the individual's risk tolerance level. Such information will be of use both for the individuals themselves, and for their financial advisors, who will then be able to assist clients in making financial decisions in a manner more in sympathy with their clients' attitude towards risk. For example, where an advisor would normally commend a course of action which involves a level of risk greater than the client's tolerance, both client and advisor can be made aware of the conflicts so that they can work towards a compromise. Similarly, where a course of action involves a level of risk lower than the client's risk tolerance, the client and the advisor can decide to shift investment to riskier instruments. Without assessment of the individual PFRT, such conflicts between desired and actual levels of financial risk may never be identified, or possibly worse, may be identified after the fact.

The Financial Services industry touches every adult to some extent. Credit, banking, investment decisions, insurance, loans, purchases, and so on are all parts of the Financial Services industry, which underpins the very foundation of modern day society.

A known risk tolerance instrument is described in the “Survey of Financial Risk Tolerance” (SOFRT), developed by The American College, of 270 S. Bryn Mawr Avenue, Bryn Mawr, Pa. 19010, and released in 1994. The College is a private US University established by the Insurance industry in the 1970s. The author of the survey is Michael J. Roszkowski PhD. The above-referenced risk tolerance instrument operates by providing an individual with a questionnaire. Each answer is scored by using the number chosen. The sequence of choices is either from low risk to high risk, or high risk to low risk. In the latter case, the choice numbers are reversed during scoring. Two overall scores are then calculated: a Risk Tolerance Score and a Consistency Score. The Risk Tolerance Score is scaled linearly in the range 0, which represents total risk averse, to 100, which represents total risk enthusiastic.

The PFRT of an individual is especially important in determining the above-average risk portion size, out of the individual total investment capital, that keeps the individual comfortable.

Another example of a survey for risk assessment is the Survey of Consumer Finances (SCF) which contains a single risk assessment item: “which of the following statements comes closest to the amount of financial risk that you are willing to take when you save or make investments? (1) Take substantial financial risk expecting to earn substantial return. (2) Take above average financial risk expecting to earn above average return. (3) Take average financial risk expecting to earn average return. (4) Not willing to take any financial risks.”

The anxiety of the investor, in face of a fast decreasing market, like the stock market crash that took place during the year 2008, is another important factor to be taken into account. In accordance with the above background, this anxiety can be associated to great extent to the subjective fear of capital loss as perceived by the investor. This anxiety is much intensified in face of bigger market uncertainties, i.e. lack of knowledge on the size of the capital in risk for loss. Investor anxiety causes the investor to make irrational decisions which can cause financial harm with far reaching effects.

This anxiety can be measured using many tools, such as the State-Trait Anxiety Inventory (STAI), an investment variation of modified Yale Preoperative Anxiety Scale (mYPAS), modified visual scales like Wong-Baker FACES scale, other custom made scales etc.

Hence, a means and methods for managing an investment portfolio management according to an investor's personal financial risk tolerance, meets a long felt need. Furthermore, means and methods for reducing the tendency for an investor to make irrational decisions due to anxiety meets a long felt need.

### SUMMARY OF THE INVENTION

### The Infinity AI-AM (Anti Irrational Asset Management) Method and System

Academic knowledge in behavioral economics and behavioral finance has increased tremendously in recent years. Work by Nobel Prizewinning professors Kahneman and Twersky has demonstrated the use of cognitive models of decision-making under risk and uncertainty to explain economic models of rational and irrational human behavior and decision making. Behavioral economics and finance theories were originally developed from experimental observations and survey responses, but recently brain imaging technology has enabled the direct observation of brain activity during economic decision making, as well as related stress, anxiety and euphoric responses to real or perceived financial investment situations. Nevertheless, until now, there has been no real progress in applying this new knowledge of emotionally and perceptional driven individual economic behavior to practical proven asset management mechanism and portfolio management.

An investment method and system is herein described which exploits the linkage between behavioral finance and individual investment rationale.

The impact of applying the method for asset management firms is dramatic and significant due to the reduction of unsatisfied clients (professionally or emotionally). Satisfied clients expand their duration under the firm's management and there is an increased capitalization of fees from them.

This present invention provides and discloses a novel analytical system and associated algorithms useful for protecting the investor from making irrational decisions by lowering investor's anxiety and managing an investment portfolio according to an investor's personal financial risk tolerance. The avoidance of costly irrational decisions is crucial to maximizing gains over a given period of time.

The breakthrough here is that the individual investor is assessed for risk tolerance and for euphoric gain impact. An investment portfolio is selected that optimizes certain metrics related both to ROI and the given investor's risk tolerance.

The core of the present invention is to provide means and methods for managing an investment according to an investor's personal financial risk tolerance in two separate and independently managed portfolios, high-risk portfolio and low-risk portfolio, thus reducing the investor's anxiety, meets a long felt need.

It is within the scope of the present invention to disclose a method for reducing investor anxiety, comprising steps of: (a) providing a SAFE portfolio investment anxiety scale card (IASC) and a RISK portfolio IASC; (b) assessing investor's anxiety value by implementing the SAFE portfolio IASC and the RISK portfolio IASC, on the investor; (c) allocating the investor's capital initially into: (i) a managed SAFE portfolio having a first predetermined initial size comprising at least one subset of SAFE portfolios; (ii) a managed RISK portfolio having a second predetermined initial size comprising at least one subset of RISK portfolios; (d) determining range values for the two portfolios, comprising steps of: (i) determining minimal allowed SAFE value, maximal allowed SAFE value and optimal SAFE value for the managed SAFE portfolio, according to predetermined statistical data, such that the optimal SAFE value is larger than the minimal allowed SAFE value and smaller than the maximal allowed SAFE value; (ii) determining minimal allowed RISK value, maximal allowed RISK value and optimal RISK value for the managed RISK portfolio, according to predetermined statistical data, such that the optimal RISK value is larger than the minimal allowed RISK value and smaller than the maximal allowed RISK value; (e) calibrating the two IASC cards, comprising steps of: (i) marking the minimal allowed SAFE value, the maximal allowed SAFE value and the optimal SAFE value of the SAFE portfolio IASC; (ii) marking the minimal allowed RISK value, the maximal allowed RISK value and the optimal RISK value of the RISK portfolio IASC; (f) adjusting allocation size of the two portfolios, comprising steps of: (i) adjusting size of the SAFE portfolio, such that the investor's anxiety value is substantially equal to the optimal SAFE value, is larger than the minimal allowed SAFE value and smaller than the maximal allowed SAFE value; (ii) adjusting size of the RISK portfolio, such that the investor's anxiety value is substantially equal to the optimal RISK value, is larger than the minimal allowed RISK value and smaller than the maximal allowed RISK value; (iii) reassessing the investor's anxiety value by implementing the SAFE portfolio IASC and the RISK portfolio IASC, on the investor; (iv) repeating steps (i) to (iii), until investor's anxiety value is within permitted range for the two portfolios; (g) managing the investor's capital in the two portfolios; and (h) withdrawing at least part of said investor's capital from at least one of said portfolios; wherein said step of managing is performed independently for each of said two portfolios, such that said two portfolios are isolated from one another.

It should be emphasized that the investor himself may carry out the aforementioned transactions, which has certain advantages over systems entirely controlled by a financial advisor. For example, the investor may enjoy a greater feeling of control over his/her finances, may be more assured that the results obtained are due to his/her own efforts, and may be less susceptible to suspect that results obtained are due to inferior management. Finally, the investor may derive an increased sense of safety if he/she is the party to carry out transactions.

The tendency of an investor to make irrational decisions due to anxiety is reduced by the implementation of the means and methods provided by the present invention and herein disclosed.

It is further within the scope of the present invention that the abovementioned method additionally comprising step of readjusting allocation size of the two portfolios, comprising steps of: (a) adjusting size of the SAFE portfolio, such that the investor's anxiety value is substantially equal to the optimal SAFE value, is larger than the minimal allowed SAFE value and smaller than the maximal allowed SAFE value; (b) adjusting size of the RISK portfolio, such that the investor's anxiety value is substantially equal to the optimal RISK value, is larger than the minimal allowed RISK value and smaller than the maximal allowed RISK value; (c) reassessing the investor's anxiety value by implementing the SAFE portfolio IASC and the RISK portfolio IASC, on the investor; (d) repeating steps (a) to (c), until investor's anxiety value is within permitted range for the two portfolios; the additional step is performed at a predetermined interval subsequent to the time at which the investor's capital was initially allocated.

It is further within the scope of the present invention wherein the step of managing the investor's capital in the two portfolios is performed using Optimal Portfolio Model according to commonly acceptable standards, such that an optimal portfolio composition is obtained in each of the two portfolios.

It is further within the scope of the present invention wherein the step of managing is performed using an external brokerage firm.

It is further within the scope of the present invention that the abovementioned method additionally comprising step of assessing the investor's anxiety value using a Reverse Financial Engineering (RFE) model.

It is further within the scope of the present invention that the abovementioned method additionally comprising step of managing the investor's capital in the SAFE portfolio with substantially below average volatility, such that the capital preservation of the SAFE portfolio is achieved.

It is further within the scope of the present invention that the abovementioned method additionally comprising step of managing the investor's capital in the RISK portfolio with substantially above average volatility, such that the capital appreciation of the RISK portfolio is achieved.

It is further within the scope of the present invention that the abovementioned method additionally comprising step of evaluating the performance of each of the two portfolios, by means of comparing the performances to well-known benchmarks according to accepted standards.

It is further within the scope of the present invention that the abovementioned method variation additionally comprising step of reporting the performances to the investor.

It is further within the scope of the present invention that the abovementioned method additionally comprising step of managing the RISK portfolio, such that gain acceleration is achieved during bull market periods.

It is further within the scope of the present invention that the abovementioned method additionally comprising step of managing the RISK portfolio, such that loss deceleration is achieved during bear market periods.

It is further within the scope of the present invention that the abovementioned method additionally comprising step of managing the two portfolios using periodically charged management fees as a fixed percentage of each of the two portfolio size.

It is within scope of the invention to provide that transactions be initiated on the part of the investor, and not only on the part of a financial advisor or investment manager.

It is further within the scope of the present invention that the abovementioned method variation additionally comprising step of managing the SAFE portfolio using reduced management fees compared to the management fees of the RISK portfolio.

It is further within the scope of the present invention that the abovementioned method additionally comprising a step of transferring capital from the RISK portfolio to the SAFE portfolio, at periods and amounts under the investor's discretion, such that the ratio between the RISK portfolio size and the investor's capital is reduced.

It is further within the scope of the present invention that the abovementioned method additionally comprising a step of periodically withdrawing capital from the SAFE portfolio, by means of a predetermined annuity mechanism, such that a steady income cash flow for the investor is obtained.

It is further within the scope of the present invention that the abovementioned method additionally comprising step of managing a second set of two mixed portfolios, characterized by the same initial size as the isolated portfolios, wherein the total amount of the investor's capital in any given time within the isolated portfolios is bigger than the total amount of the investor's capital within the mixed portfolios.

It is within the scope of the present invention to disclose a computer implemented method for reducing investor's anxiety, comprising steps of: (a) assessing the personal financial risk tolerance (PFRT) of the investor by operating a computer implemented survey of financial risk tolerance (SOFRT) calculator for calculating the PFRT of the investor; (b) allocating the investor's capital into: (i) a managed SAFE portfolio comprising at least one subset of SAFE portfolios, the managed SAFE portfolio characterized by a size, such that the ratio between the size of the managed SAFE portfolio to investor's capital is inversely proportional to the investor score on the PFRT; and (ii) a managed RISK portfolio comprising at least one subset of RISK portfolios, the managed RISK portfolio characterized by a size which is the remainder of the investor's capital after allocating the managed SAFE portfolio; and (c) managing the investor's capital in the two portfolios; wherein the step of managing is performed independently for each of the two portfolios, such that no part of the investor's capital is transferred between the two portfolios.

It is further within the scope of the present invention that the abovementioned method additionally comprising steps of: (a) reassessing the PFRT of the investor by operating the SOFRT calculator for calculating the PFRT of the investor; and (b) transferring part of the investor's capital between the two portfolios, such that after the step of transferring, the ratio between the size of the managed SAFE portfolio to the investor's capital is inversely proportional to the investor reassessed PFRT and the size of the managed RISK portfolio is the remainder of the investor's capital; the additional steps of reassessing (a) and of transferring (b) are performed at predetermined intervals subsequent to the time at which the investor's capital was initially allocated. Additional reassessments and transfer may be carried out due to external factors such as war, famine, plague, inheritances, bankruptcies, and other changes in the balance of a user's capital or changes in the financial landscape. It is herein acknowledged that the present invention herein disclosed enables the aforementioned alterations and reassessments to be made according to changes and Benchmarks in the lifecycle of the investor and his family or intersts or dependents, such as births, deaths, marriages, illness, unemployment periods, coming of age, educational milestones, legacies, inheritances, buy- outs,property sales and other events which may have an effect on the investors needs and requirements, short term and long term.

It is further within the scope of the present invention wherein the step of managing the investor's capital in the two portfolios is performed using Optimal Portfolio Model according to commonly acceptable standards, such that an optimal portfolio composition is obtained in each of the two portfolios.

It is further within the scope of the present invention wherein the step of managing is performed using an external brokerage firm.

It is further within the scope of the present invention that the abovementioned method additionally comprising step of assessing the PFRT using a Reverse Financial Engineering (RFE) model.

It is further within the scope of the present invention that the abovementioned method additionally comprising step of managing the investor's capital in the SAFE portfolio with substantially below average volatility, such that the capital preservation of the SAFE portfolio is achieved.

It is further within the scope of the present invention that the abovementioned method additionally comprising step of managing the investor's capital in the RISK portfolio with substantially above average volatility, such that the capital appreciation of the RISK portfolio is achieved.

It is further within the scope of the present invention that the abovementioned method additionally comprising step of evaluating the performance of each of the two portfolios, by means of comparing the performances to well-known benchmarks according to accepted standards.

It is further within the scope of the present invention that the abovementioned method variation additionally comprising step of reporting the performances to the investor.

It is further within the scope of the present invention that the abovementioned method additionally comprising step of managing the RISK portfolio, such that gain acceleration is achieved during bull market periods.

It is further within the scope of the present invention that the abovementioned method additionally comprising step of managing the RISK portfolio, such that loss deceleration is achieved during bear market periods.

It is further within the scope of the present invention that the abovementioned method additionally comprising step of managing the two portfolios using periodically charged management fees as a fixed percentage of each of the two portfolio size.

It is further within the scope of the present invention that the abovementioned method variation additionally comprising step of managing the SAFE portfolio using reduced management fees compared to the management fees of the RISK portfolio.

It is further within the scope of the present invention that the abovementioned method additionally comprising a step of transferring capital from the RISK portfolio to the SAFE portfolio, at periods and amounts under the investor's discretion, such that the ratio between the RISK portfolio size and the investor's capital is reduced.

It is further within the scope of the present invention that the abovementioned method additionally comprising a step of periodically withdrawing capital from the SAFE portfolio, by means of a predetermined annuity mechanism, such that a steady income cash flow for the investor is obtained.

It is further within the scope of the present invention to disclose a computer-readable medium having computer-executable instructions for performing a method for reducing investor's anxiety, the method comprising steps of: (a) assessing the personal financial risk tolerance (PFRT) of the investor by operating a computer implemented survey of financial risk tolerance (SOFRT) calculator for calculating the PFRT of the investor; (b) allocating the investor's capital into: (i) a managed SAFE portfolio, characterized by a size such that the ratio between the size of the managed SAFE portfolio to investor's capital is inversely proportional to the investor score on the PFRT, (ii) a managed RISK portfolio, characterized by a size which is the remainder of the investor's capital after allocating the managed SAFE portfolio; (c) managing the investor's capital in the two portfolios; wherein the step of managing is performed independently for each of the two portfolios, such that no part of the investor's capital is transferred between the two portfolios.

It is further within the scope of the present invention that the abovementioned method performed by the abovementioned computer-executable instructions within the abovementioned computer-readable medium additionally comprising steps of: (a) reassessing the PFRT of the investor by operating the SOFRT calculator for calculating the PFRT of the investor; and (b) transferring part of the investor's capital between the two portfolios, such that after the step of transferring, the ratio between the size of the managed SAFE portfolio to the investor's capital is inversely proportional to the investor reassessed PFRT and the size of the managed RISK portfolio is the remainder of the investor's capital; the additional steps of reassessing (a) and of transferring (b) are performed at a predetermined interval subsequent to the time at which the investor's capital was initially allocated.

It is further within the scope of the present invention that the abovementioned step of managing the investor's capital in the two portfolios in the abovementioned method performed by the abovementioned computer-executable instructions within the abovementioned computer-readable medium is performed using Optimal Portfolio Model according to commonly acceptable standards, such that an optimal portfolio composition is obtained in each of the two portfolios.

It is further within the scope of the present invention that the abovementioned step of managing the investor's capital in the two portfolios in the abovementioned method performed by the abovementioned computer-executable instructions within the abovementioned computer-readable medium is performed using an external brokerage firm.

It further within the scope of the present invention that the abovementioned method performed by the abovementioned computer-executable instructions within the abovementioned computer-readable medium additionally comprises step of assessing the PFRT using a Reverse Financial Engineering (RFE) model.

It is further within the scope of the present invention that the abovementioned method performed by the abovementioned computer-executable instructions within the abovementioned computer-readable medium additionally comprising step of managing the investor's capital in the SAFE portfolio with substantially below average volatility, such that the capital preservation of the SAFE portfolio is achieved.

It is further within the scope of the present invention that the abovementioned method performed by the abovementioned computer-executable instructions within the abovementioned computer-readable medium additionally comprising step of managing the investor's capital in the RISK portfolio with substantially above average volatility, such that the capital appreciation of the RISK portfolio is achieved.

It is further within the scope of the present invention that the abovementioned method performed by the abovementioned computer-executable instructions within the abovementioned computer-readable medium additionally comprising step of evaluating the performance of each of the two portfolios, by means of comparing the performances to well-known benchmarks according to accepted standards.

It further within the scope of the present invention that the abovementioned method performed by the abovementioned computer-executable instructions within the abovementioned computer-readable medium additionally comprises step of reporting the performances to the investor.

It is further within the scope of the present invention that the abovementioned method performed by the abovementioned computer-executable instructions within the abovementioned computer-readable medium additionally comprising step of managing the RISK portfolio, such that gain acceleration is achieved during bull market periods.

It is further within the scope of the present invention that the abovementioned method performed by the abovementioned computer-executable instructions within the abovementioned computer-readable medium additionally comprising step of managing the RISK portfolio, such that loss deceleration is achieved during bear market periods.

It is further within the scope of the present invention that the abovementioned method performed by the abovementioned computer-executable instructions within the abovementioned computer-readable medium additionally comprising step of managing the two portfolios using periodically charged management fees as a fixed percentage of each of the two portfolio size.

It is further within the scope of the present invention that the abovementioned method performed by the abovementioned computer-executable instructions within the abovementioned computer-readable medium additionally comprising step of managing the SAFE portfolio using reduced management fees compared to the management fees of the RISK portfolio.

It is further within the scope of the present invention that the abovementioned method performed by the abovementioned computer-executable instructions within the abovementioned computer-readable medium additionally comprising a step of transferring capital from the RISK portfolio to the SAFE portfolio, at periods and amounts under the investor's discretion, such that the ratio between the RISK portfolio size and the investor's capital is reduced.

It further within the scope of the present invention that the abovementioned method performed by the abovementioned computer-executable instructions within the abovementioned computer-readable medium additionally comprises a step of periodically withdrawing capital from the SAFE portfolio, by means of a predetermined annuity mechanism, such that a steady income cash flow for the investor is obtained.

It is within the scope of the present invention to disclose a system for investment portfolio management and reduction of investor's anxiety, comprising: (a) at least one storage device; (b) at least one input means; (c) at least one processor operable to: (i) assess the personal financial risk tolerance (PFRT) of the investor by operating a computer implemented survey of financial risk tolerance (SOFRT) calculator for calculating the PFRT of the investor; the PFRT is stored in the at least one storage device; (ii) allocate, by means of the at least one input means, the investor's capital into: a managed SAFE portfolio, characterized by a size such that the ratio between the size of the managed SAFE portfolio to investor's capital is inversely proportional to the investor score on the PFRT and a managed RISK portfolio, characterized by a size which is the remainder of the investor's capital after allocating the managed SAFE portfolio; the portfolios sizes are stored in the at least one storage device; (iii) manage the investor's capital in the two portfolios; wherein the management of the investor's capital in the two portfolios is performed by the at least one processor independently for each of the two portfolios, such that no part of the investor's capital is transferred between the two portfolios.

It is within the scope of the present invention to disclose a pair of portfolio investment anxiety cards useful to reduce investor's anxiety, comprising (a) a SAFE portfolio investment anxiety scale card (IASC) and (b) a RISK portfolio IASC, used in conjunction with a method comprising steps comprising steps of: (a) providing the SAFE portfolio IASC and the RISK portfolio IASC; (b) assessing investor's anxiety value by implementing the SAFE portfolio IASC and the RISK portfolio IASC, on the investor; (c) allocating the investor's capital initially into: (i) a managed SAFE portfolio having a first predetermined initial size comprising at least one subset of SAFE portfolios; (ii) a managed RISK portfolio having a second predetermined initial size comprising at least one subset of RISK portfolios; (d) determining range values for the two portfolios, comprising steps of: (i) determining minimal allowed SAFE value, maximal allowed SAFE value and optimal SAFE value for the managed SAFE portfolio, according to predetermined statistical data, such that the optimal SAFE value is larger than the minimal allowed SAFE value and smaller than the maximal allowed SAFE value; (ii) determining minimal allowed RISK value, maximal allowed RISK value and optimal RISK value for the managed RISK portfolio, according to predetermined statistical data, such that the optimal RISK value is larger than the minimal allowed RISK value and smaller than the maximal allowed RISK value; (e) calibrating the two IASC cards, comprising steps of: (i) marking the minimal allowed SAFE value, the maximal allowed SAFE value and the optimal SAFE value of the SAFE portfolio IASC; (ii) marking the minimal allowed RISK value, the maximal allowed RISK value and the optimal RISK value of the RISK portfolio IASC; (f) adjusting allocation size of the two portfolios, comprising steps of (i) adjusting size of the SAFE portfolio, such that the investor's anxiety value is substantially equal to the optimal SAFE value, is larger than the minimal allowed SAFE value and smaller than the maximal allowed SAFE value; (ii) adjusting size of the RISK portfolio, such that the investor's anxiety value is substantially equal to the optimal RISK value, is larger than the minimal allowed RISK value and smaller than the maximal allowed RISK value; (iii) reassessing the investor's anxiety value by implementing the SAFE portfolio IASC and the RISK portfolio IASC, on the investor; (iv) repeating steps (i) to (iii), until investor's anxiety value is within permitted range for the two portfolios; and (g) managing the investor's capital in the two portfolios; wherein management of the investor's is performed independently for each of the two portfolios, such that the two portfolios are isolated from one another.

It is another object of the invention to disclose a method as defined in any of the above wherein said investor is individually assessed for euphoric gain impact.

It is another object of the invention to disclose a method as defined in any of the above wherein said investment portfolio selection includes a step of euphoric gain impact assessment.

It is another object of the invention to disclose a method for managing an investment portfolio management according to an investor's personal financial risk tolerance or anxiety level wherein said investor's resources are divided by at least one Reverse Financial engineering algorithm into multiple independently pure risk type managed portfolios comprising a “SAFE Cap” portfolio of “protected” conservative type assets, for funding a basic cash stream to said investor; and “RISK cap” portfolio, of “high volatility” venture type assets.

It is another object of the invention to disclose a method as defined in any of the above wherein said “SAFE Cap” portfolio is managed and determined by an algorithm which triggers appropriate action resulting in value fluctuations at a lower than average volatility.

It is another object of the invention to disclose a method as defined in any of the above wherein said “RISK Cap” portfolio is managed and determined by an algorithm triggering appropriate action resulting in value fluctuations at a higher than average volatility.

It is another object of the invention to disclose a method as defined in any of the above wherein a rebalancing process is undergone at certain intervals for optimizing the size and values of the “SAFE Cap” and the “RISK Cap” according to the client's lifecycle and needs and is triggered by performance and market events and influences such that when the “RISK Cap” has achieved predetermined surpluses, it feeds dividends into the “SAFE Cap” to an extent determined by said individual investor's lifecycle and needs and the “SAFE Cap” funds cash flow needs, and when it has outperformed its predetermined targets, it also contributes to the “RISK Cap” to enlarge leverage.

### BRIEF DESCRIPTION OF THE DRAWINGS

In order to better understand the invention and its implementation in a practice, a plurality of embodiments will now be described, by way of non-limiting example only, with reference to the accompanying drawings, in which

FIG. 1 graphically illustrates in a preferred embodiment an example for an investment anxiety scale card (IASC);

FIG. 2 graphically illustrates, according to another preferred embodiment of the present invention, the evolution through time of the investor's capital, as well as its internal behavior within the RISK portfolio and within the SAFE portfolio, for both the mixed portfolios (prior art) case and the separately managed portfolios (present invention) case, in adverse market conditions;

FIG. 3 graphically illustrates, according to the preferred embodiment of the present invention, the evolution through time of the investor's capital, as well as its internal behavior within the RISK portfolio and within the SAFE portfolio, for both the mixed portfolios (prior art) case and the separately managed portfolios (present invention) case, in favorable market conditions;

FIG. 4 graphically illustrates, according to another preferred embodiment of the present invention, an example of an increasing market special case of “fixation” of gains by transferring potential gains accumulated at the RISK portfolio to the SAFE portfolio;

FIG. 5 demonstrates, using a table, according to the preferred embodiment of the present invention, the benefits of one example of the present invention over the prior art, in the case of a plummeting market;

FIG. 6 demonstrates, using a table, according to the preferred embodiment of the present invention, the benefits of one example of the present invention over the prior art, in the case of a soaring market; and

FIG. 7A-C describes the utility of the current invention.

### DETAILED DESCRIPTION OF THE PREFERRED EMBODIMENTS

The following description is provided, along all chapters of the present invention, so as to enable any person to make use of said invention and sets forth the best modes contemplated by the inventor of carrying out this invention. As is customary, it will be understood that no limitation of the scope of the invention is thereby intended. Further modifications will remain apparent to those skilled in the art, since the generic principles of the present invention have been defined specifically to provide means and methods for managing an investment portfolio management according to an investor's personal financial risk tolerance or anxiety level.

The points below characterize the method and system of the present invention:

1. The investor's resources are divided by Reverse Financial engineering algorithm into multiple independently pure risk type managed portfolios:

a. “SAFE Cap” portfolio, which consist of “protected” conservative type assets, in order to fund a basic cash stream to the investor which is determined by a proprietary reverse financial engineering algorithm; and,

b. “RISK cap” portfolio, which consist of “high volatility” venture type assets, to take advantage of market opportunities which is also algorithmically driven (Indices benchmarking, core and satellite allocation etc.).

2. The “SAFE Cap” portfolio is managed by a proprietary algorithm which triggers appropriate action resulting in value fluctuations at a lower than average volatility.

3. The “RISK Cap” portfolio is managed by a proprietary algorithm triggering appropriate action resulting in value fluctuations at a higher than average volatility.

4. A rebalancing process is undergone at certain intervals to optimize the size and values of the “SAFE Cap” and the “RISK Cap” according to the client's lifecycle and needs and is triggered by performance and market events and influences:

a. When the “RISK Cap” has achieved predetermined surpluses, it feeds dividends into the “SAFE Cap” to an extent determined by the individual investor's needs; and

b. The “SAFE Cap” funds cash flow needs, and when it has outperformed its targets, it also contributes to the “RISK Cap” to enlarge leverage.

The terms “investor”, “customer”, “client” and “user”, used interchangeably in the present invention, refers hereinafter to any party that makes an investment.

The terms “capital” refers hereinafter to any financial assets or to the financial value of assets.

The terms “custom-made” and “custom-tailored”, used interchangeably in the present invention, refers hereinafter to any action that is performed in order to accommodate the special needs, desires or requirements of a certain investor or customer.

The term “cash allocation” refers hereinafter to the partition of capital, funds, money, securities etc. to at least two portfolios or sub portfolios, or between these portfolios or sub portfolios.

The term “leverage” refers hereinafter to any technique or attribute for multiplying gains.

The term “Optimal Portfolio Model” refers hereinafter to any model for building a portfolio such that an optimal portfolio is obtained in terms of one or more of a variety of factors such as expected return and standard deviation of the portfolio. Alternatively or additionally this can refer to a portfolio consisting of a weighted sum of every asset in the market, with weights in the proportions that they exist in the market creation method.

The terms “base capital”, “SAFE portfolio”, “low-risk capital” and “no-risk capital”, used interchangeably in the present invention, refers hereinafter to cash, money, funds, capital, securities etc. that are invested in substantially below-average-risk financial tools, selected from a group consisting of, stocks, securities, funds, mutual funds, currency market, options, commodities, etc. or any combination thereof.

The terms “venture capital”, “RISK portfolio”, “risk capital” and “high risk capital”, used interchangeably in the present invention, refers hereinafter to cash, money, funds, capital, securities etc. that are invested in substantially above-average-risk financial tools, selected from a group consisting of, stocks, securities, funds, mutual funds, currency market, options, commodities, etc. or any combination thereof.

The term “Independent Financial Manager” or the term “Independent Financial Management” or “IFM” refers hereinafter to an executive or method or processes that for selecting financial products on objective criteria alone which are established with only the client's financial interests in mind. No relative financial benefits are received from financial product suppliers which would induce the IFM to prefer one financial product over another, since he/she is not connected to any supplier of financial services or instruments.

The term “Reverse Financial Engineering model” or “RFE model” refers hereinafter to any financial model that is aimed at redistributing the relative allocations in a portfolio or portfolios to match the risk tolerance or anxiety level of an individual, or any other personal parameters of an individual, according to predetermined metrics.

The terms “volatility” and “variation”, used interchangeably in the present invention, refers hereinafter to the amount of uncertainty or risk due to changes in a security's value, or to a statistical measure of the dispersion of returns for a given security or market index. Volatility can either be measured by using the standard deviation or variance over some time period for that same security or market index.

The terms “return” and “yield”, used interchangeably in the present invention, refer hereinafter to the gain or loss of a security in a particular period, or to the income return on an investment. The return includes interest and dividends received from a security and is usually expressed as an annual percentage change based on the investment's original cost, its current market value, or its face value.

The term “Capital Preservation” refers hereinafter to the preservation or safeguarding of capital, funds, money, cash, securities, portfolio etc. by any action taken in order to avoid undesired loss. This term refers to loss from the total investment portfolio of the investor, and not loss from a particular investment.

The term “Capital Appreciation” refers hereinafter to the appreciation or raise in value of capital, funds, money etc. by any action taken in order to increase the gains.

The term “investment manager” refers hereinafter to any organization, firm, company, corporation, government agency, bank, broker or body that manages an investment.

The term “bull market” refers hereinafter to financial market of a group of securities in which prices are rising or are expected to rise.

The term “bear market” refers hereinafter to a market condition in which the prices of securities are falling, and widespread pessimism causes the negative sentiment to be self-sustaining.

The term “annual return” refers hereinafter to the annual change or rate of change either in terms of nominal value or real value or the annual currency rate change, inflation related annual change, interest rate change, any other annual or periodical change, or any combination thereof.

The term “Personal Financial Risk Tolerance” or “PFRT” refers hereinafter to any scale designated to measure the personal financial risk tolerance or anxiety.

The term “Survey of Financial Risk Tolerance” or “SOFRT” refers hereinafter to the tool developed by The American College of Bryn Mawr and released in 1994, designed to measure the PFRT of an individual.

The term “Return on Investment” or “ROI” refers hereinafter to any performance measure used to evaluate the efficiency of an investment or to compare the efficiency of a number of different investments.

The term “self dividend” refers hereinafter to any transfer of capital from a first portfolio to a second portfolio, where the first portfolio is characterized by a volatility which is higher on average than the volatility of the second portfolio.

The terms “Gain Accelerator” and “Gain Acceleration”, used interchangeably in the present invention, refers hereinafter to increase of the rate of change of the gain, to the increase of the change of gain or the increase of the gain itself, or to a means for performing any of these increases.

The terms “Loss Decelerator” and “Loss Deceleration”, used interchangeably in the present invention, refers hereinafter to the limiting of the rate of change of the loss incurred in any portfolio, or to the limiting of the change of the loss, or to the limiting of the loss itself, or to a means for performing any of these limiting.

The term “well-known benchmarks” refers hereinafter to comparison means selected from a group consisting of any index, currency rate, historic rate average, bonds performance, Treasury bond performance, average bank deposit rates, other deposit rates, any other popular index, rates or any combination thereof.

The term “anxiety scale” refers hereinafter to any measuring means for anxiety or for risk such as the State-Trait Anxiety Inventory (STAI), an investment variation of modified Yale Preoperative Anxiety Scale (mYPAS), modified visual scales like Wong-Baker FACES scale, other custom made scales, Survey of Consumer Finances (SCF), or any other scales used for this purpose, and any combination thereof.

The term “investment anxiety scale card” or “IASC” refers hereinafter to any physical card associated with a scale designated to measure the investment anxiety according to any anxiety scale as defined above.

The term “statistical data” refers hereinafter to any historical data, processed or raw, that is used for determining any set of given parameters.

The term “isolated portfolios” refers hereinafter to any portfolios that are separated from one another, such that for any given pair of portfolios no capital is being transferred between the two portfolios by the financial manager.

The term “mixed portfolios” refers hereinafter to any portfolios that are not isolated portfolios. Alternatively or additionally, the term “mixed portfolios” refers hereinafter to any portfolios that are not separated from one another. Capital may be transferred within the mixed portfolio, from high risk investments to low risk investments or vice versa, by the investment manager. Capital may not be transferred out of the mixed portfolio. In some example this can be done in a predetermined manner.

The term ‘risk of loss’ for an investment having a present future value described by a Gaussian with center p and standard deviation a is defined by:

$$\frac{σ}{\sqrt{2 π}} exp ( - \frac{{μ}^{2}}{2 {σ}^{2}} ) + \frac{1}{2} μ Erf ( \frac{μ}{σ \sqrt{2}} ) - \frac{μ}{2}$$

An example of a method for financial asset management as described in the present invention is a method for financial asset management, based on cash allocation of the investment into two separate layers: a “base capital” layer (or “low-risk capital”) and a “venture capital” (or “risk capital”) layer, managed in separate paths, according to a dedicated and appropriate investment policy (High Risk, No/Low Risk); portfolio building in each path is performed using an Optimal Portfolio Model according to commonly acceptable standards.

Principles of this sample method also comprise use of Reverse Financial Engineering (RFE) models, custom-tailored to the customer, according to various personal parameters such as age, personal needs and objectives, in order to determine the fractions of the total investment, that should be allocated as the “base capital”and “venture capital”.

Principles of this sample method also comprise diversified management of the capital allocated to the two layers: (a) Management of the capital allocated to the “base capital” layer in a way that allows its Capital Preservation with minimal volatility (low variation of the returns); and (b) Management of the capital allocated to the “venture capital” layer in a way that is targeted at Capital Appreciation or achieving above-average return/yield in the long term, while taking higher risks.

Principles of this sample method also comprise providing and maintaining an absolute separation between the capitals invested in each of the two layers, thus greatly limiting the risk of loss for the investor. This is in contrast to the standard management method in which the capitals are mixed together and which tries to limit the loss by maintaining a fixed ratio between the “base capital” (or between the “venture capital”) and the total investment, in any given moment, thus allowing unlimited capital depreciation.

Principles of this sample method also comprise clear and simple performance evaluation for each of the layers, by comparison to well-known benchmarks according to accepted standards.

Principles of this sample method also indicate that said absolute separation theory provides a built-in mechanism that constitutes a Gain Accelerator on the total investment amount during bull market period, when the “venture capital” layer value appreciation causes this layer to take ever increasing part of the total investment; and a Loss Decelerator during bear market period, when the “venture capital” layer value depreciation causes this layer to take ever decreasing part of the total investment.

Principles of this sample method also indicate a potential differentiated and fair management fees for the different layers, i.e. reduced management fees for the management of the “base capital” layer, thus saving money for the customer hence increasing his return over time.

Principles of this sample method also provides a potential “Self Dividend” mechanism, implemented by periodical transfer of potential gains accumulated within the “venture capital”, thus producing “fixation” of the gains and higher Return on Investment (ROI):

Principles of this sample method also provide a potential predetermined annuity mechanism, generated from the “base capital” layer, producing a steady income cash flow for the investor.

Execution steps of this sample method comprise calculating of the investor's Personal Financial Risk Tolerance (PFRT) and allocating the investor's capital into an independently managed SAFE portfolio and a independently managed RISK portfolio.

Execution steps of this sample method also comprise optimizing composition of each of the portfolios, using Optimal Portfolio Model according to commonly acceptable standards.

Execution steps of this sample method also comprise increasing the capital within the SAFE portfolio over time due to portfolio aging and by the “fixation” of gains in the RISK portfolio and transferring them into the SAFE portfolio.

Execution steps of this sample method also comprise periodical monitoring and adjusting of the size of each portfolio relative to the total investment size, according to personal changes in the investor's circumstances and/or in his PFRT.

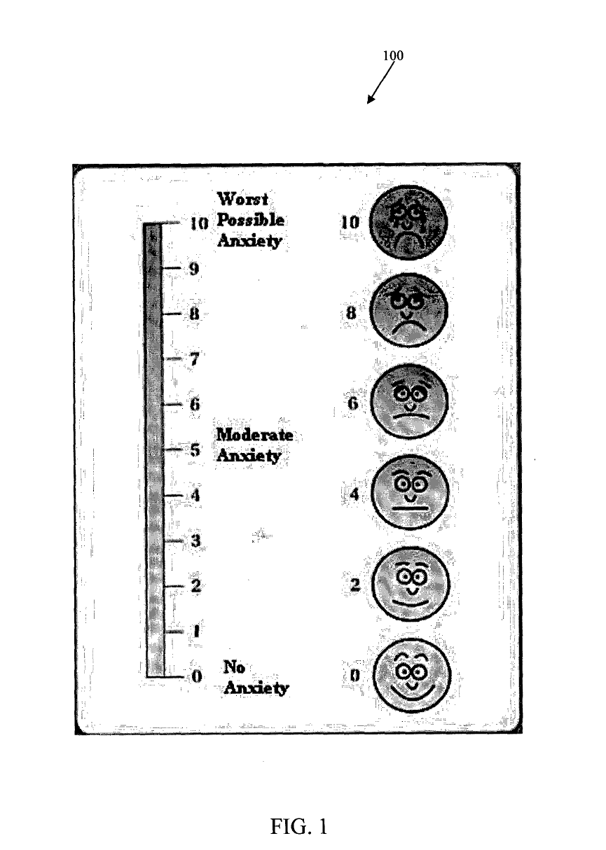

Reference is made now to FIG. 1 which graphically illustrates in a preferred embodiment an example for an investment anxiety scale card (IASC), here with a combination of a numerical scale and faces scale; the numerical scale is ranging from 0, for “No Anxiety” through 5, for “Moderate Anxiety”, to 10, for “Worst Possible Anxiety” and the faces scale, containing 6 faces, ranging from a happy face, associated with the numerical value of 0 (“No Anxiety”) to a very sad face, associated with the numerical value of 10 (“Worst Possible Anxiety”). Both the numerical scale and the faces scale are also characterized by color coding, such that a yellower color stands for lower levels of anxiety and more red colors stands for higher levels of anxiety.

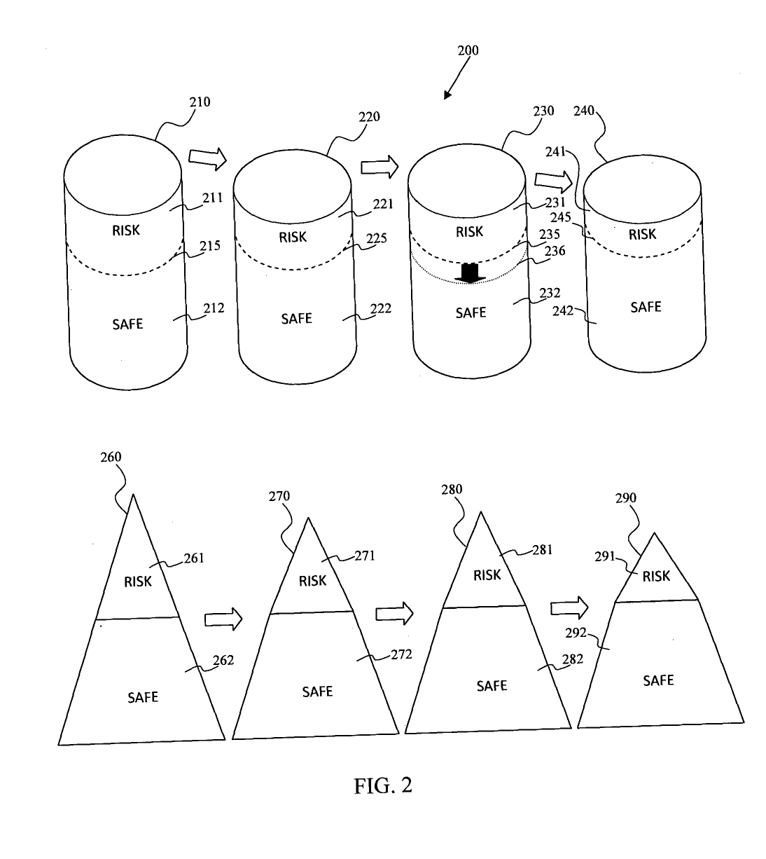

Reference is made now to FIG. 2 which graphically illustrates, according to another preferred embodiment, of the present invention the evolution through time of the investor's capital, as well as its internal behavior within the RISK portfolio and within the SAFE portfolio, for both the mixed portfolios (prior art) case and the separately managed portfolios (present invention) case, in decreasing market conditions; in this example the SAFE portfolio has a periodical growth rate of 0%, and the SAFE portfolio is very fast decreasing.

In the mixed portfolios (prior art) case, the investor's capital at period 0 (210), comprising a RISK portfolio (211) and SAFE portfolio (212), the imaginary line that set the partition between these two portfolio is marked (215), and it illustrates the fixed ratios between each of these two portfolios and the total investor's capital fixed, that are kept by the end of each period.

Just before the end of period 1 (220), the SAFE portfolio (222) size is the same, the RISK portfolio (221) size is much reduced, and the partition between the two portfolios is marked by the imaginary line (225); just before the end of period 1, in the case of a decreasing market, the part of the RISK portfolio out of the total investor's capital is still smaller that this ratio at period 0.

By the end of period 1, the total investor's capital (230) which is same as was just before the end of period 1, is changing its internal composition. Capital is transferred from the SAFE portfolio (232) to the RISK portfolio (231), thus moving the imaginary partition line from (235) to (236), in order to readjust the ratios and reset them to the predetermined fixed ratios values.

By the end of period 2, the total investor's capital (240) which is comprised of the RISK portfolio (241) and SAFE portfolio (242) is further reduced, having the imaginary partition line (245) marking the'same predetermined fixed ratios values.

In the separately managed portfolios (present invention) case, in this example, the investor's capital at period 0 (260), comprising a RISK portfolio (261) and SAFE portfolio (262), the two portfolios are kept separated and no capital is automatically transferred between the two portfolios.

Just before the end of period 1 (270), the SAFE portfolio (272) size is the same as in period 0 and the RISK portfolio (271) size is much reduced; just before the end of period 1, in the case of a decreasing market, the part of the RISK portfolio out of the total investor's capital is smaller that this ratio at period 0.

By the end of period 1 (280), the situation remains exactly the same; the SAFE portfolio (282) size is the same as in period 0 and the RISK portfolio (281) size is the same as just before the end of period 1 (and much reduced compared to period 0); no readjustment is done and no capital is transferred between the two portfolios.

By the end of period 2, the total investor's capital (290) comprises a RISK portfolio (291) and a SAFE portfolio (292). The RISK portfolio is further reduced compared to end of period 1, but this reduction is done on a much reduced size of the RISK portfolio; the SAFE portfolio on the other hand, is kept the same size; the overall effect is a reduction in the total investor's capital (290) size; however this reduction is much smaller than the reduction in the mixed portfolios (prior art) case, because of the fact that no capital has been transferred between the two portfolios and a complete separation between the two portfolios was kept.

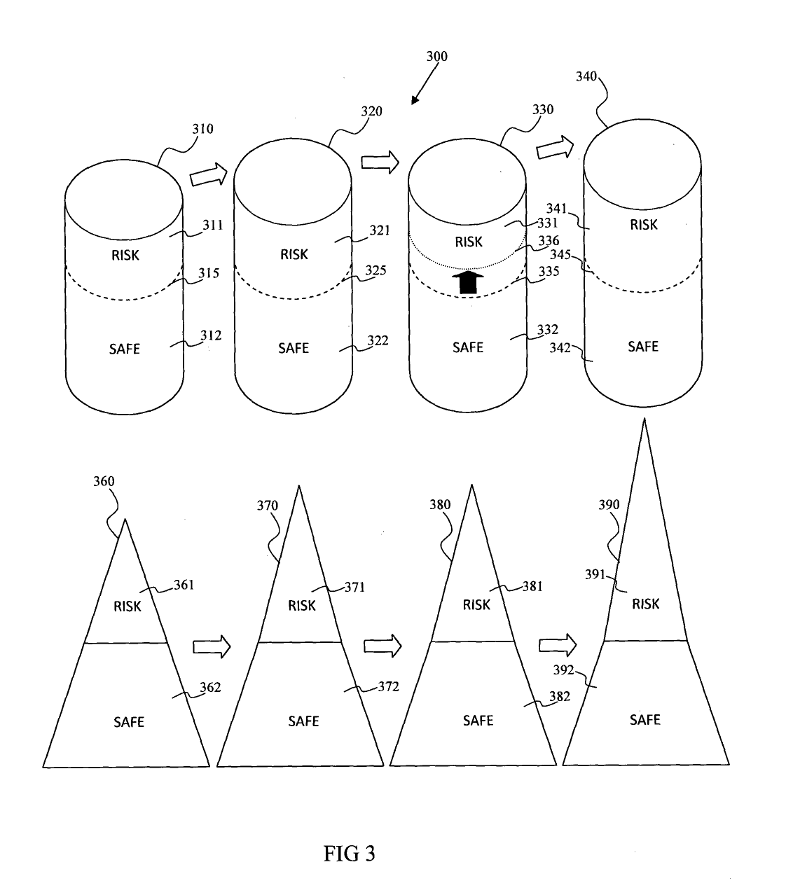

Reference is made now to FIG. 3 which graphically illustrates, according to the preferred embodiment of the present invention, the evolution through time of the investor's capital, as well as its internal behavior within the RISK portfolio and within the SAFE portfolio, for both the mixed portfolios (prior art) case and the separately managed portfolios (present invention) case, in increasing market conditions; in this example the SAFE portfolio has a periodical growth rate of 0%, and the SAFE portfolio is very fast increasing.

In the mixed portfolios (prior art) case, the investor's capital at period 0 (310), comprising a RISK portfolio (311) and SAFE portfolio (312), the imaginary line that set the partition between these two portfolio is marked (315), and it illustrates the fixed ratios between each of these two portfolios and the total investor's capital fixed, that are kept by the end of each period.

Just before the end of period 1 (320), the SAFE portfolio (322) size is the same, the RISK portfolio (321) size is much increased, and the partition between the two portfolios is marked by the imaginary line (325); just before the end of period 1, in the case of an increasing market, the part of the RISK portfolio out of the total investor's capital is still larger that this ratio at period 0.

By the end of period 1, the total investor's capital (330) which is same as was just before the end of period 1, is changing its internal composition. Capital is transferred from the RISK portfolio (332) to the SAFE portfolio (331), thus moving the imaginary partition line from (335) to (336), in order to readjust the ratios and reset them to the predetermined fixed ratios values.

By the end of period 2, the total investor's capital (340) which is comprised of the RISK portfolio (341) and SAFE portfolio (342) is further increased, having the imaginary partition line (345) marking the same predetermined fixed ratios values.

In the separately managed portfolios (present invention) case, in this example, the investor's capital at period 0 (360), comprising a RISK portfolio (361) and SAFE portfolio (362), the two portfolios are kept separated and no capital is automatically transferred between the two portfolios.

Just before the end of period 1 (370), the SAFE portfolio (372) size is the same as in period 0 and the RISK portfolio (371) size is much increased; just before the end of period 1, in the case of an increasing market, the part of the RISK portfolio out of the total investor's capital is larger that this ratio at period 0.

By the end of period 1 (380), the situation remains exactly the same; the SAFE portfolio (382) size is the same as in period 0 and the RISK portfolio (381) size is the same as just before the end of period 1 (and much increased compared to period 0); no readjustment is done and no capital is transferred between the two portfolios.

By the end of period 2, the total investor's capital (390) comprises a RISK portfolio (391) and a SAFE portfolio (392). The RISK portfolio is further increased compared to end of period 1, but this increasing is done on a much increased size of the RISK portfolio; the SAFE portfolio is kept the same size; the overall effect is an increasing in the total investor's capital (390) size; this increasing is much larger than the increasing in the mixed portfolios (prior art) case, because of the fact that no capital has been transferred away from the fast increasing RISK portfolio to the SAFE portfolio and a complete separation between the two portfolios was kept.

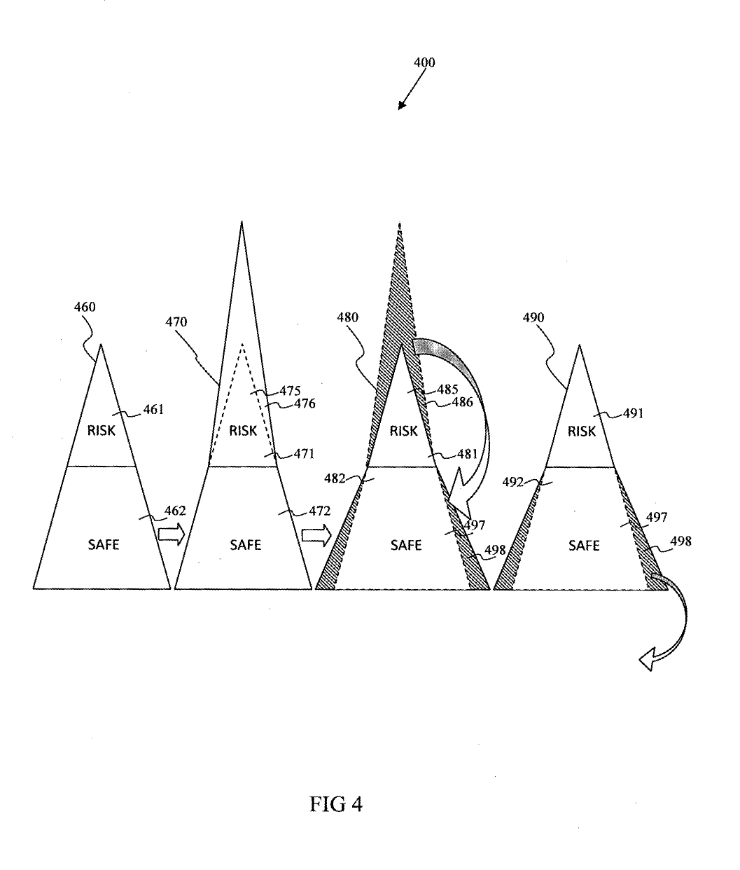

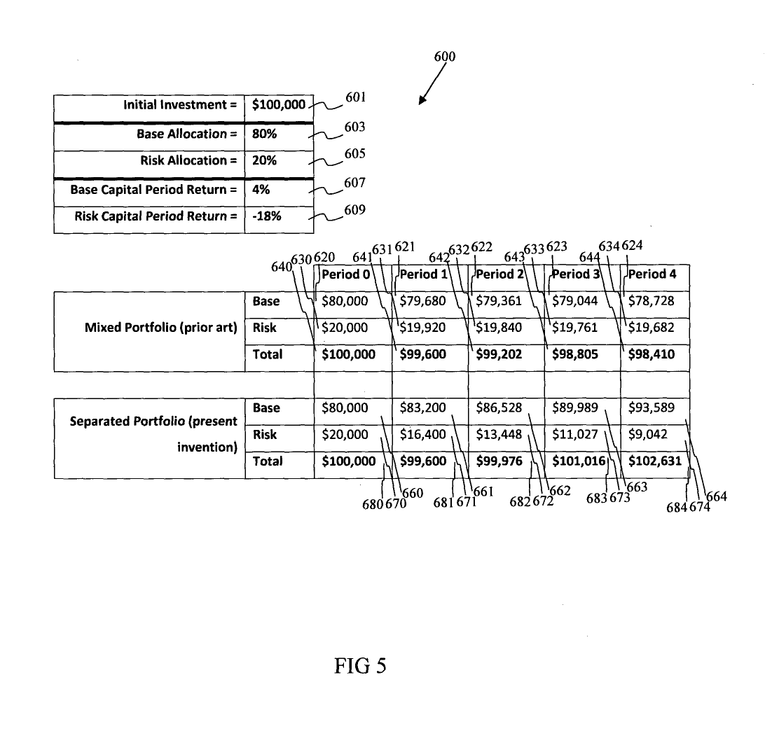

Reference is made now to FIG. 4 which graphically illustrates, according to another preferred embodiment of the present invention, an example of an increasing market special case of “fixation” of gains by transferring potential gains accumulated at the RISK portfolio to the SAFE portfolio. In this example at period 0, the investor's capital (460) is comprised by RISK portfolio (461) and SAFE portfolio (462), which are separately managed. Such a mechanism, as appears in this example, is also referred to as “self dividend”.

At period 1, the investor's capital (470) is comprised by RISK portfolio (471) and SAFE portfolio (472); the SAFE portfolio (472) remains the same size; the RISK portfolio (471) grows bigger, and can be imaginary partitioned into the previous size basic part (475) and the excess gain part (476).

At a later period F, the investor's capital (480) is comprised by RISK portfolio (481) and SAFE portfolio (482); the RISK portfolio (481) is bigger than the initial value in this example, and can be imaginary partitioned into the previous size basic part (485) and the excess gain part (486); at this period, a gain “fixation” process is illustrated, which is done non-automatically, e.g. upon request from the investor, by taking the excess gain part (486) out of the RISK portfolio and transferring it to the SAFE portfolio, thereby “fixating” the gain accumulated at the RISK portfolio; after this transfer the SAFE portfolio (482) is comprising the basic, previous, amount (497) and the excess amount (498), and the RISK portfolio (481) is reduced to its previous size (485).

FIG. 4 also illustrates graphically illustrates according to yet another preferred embodiment of the present invention, another example of an increasing market special case where periodic gain potentially accumulated within the SAFE portfolio, are being transferred to the investor's, by means of a predetermined annuity mechanism, such that a steady income cash flow for the investor is obtained. At a future period A, the investor's capital (490) is comprised by RISK portfolio (491) and SAFE portfolio (492); the SAFE portfolio (482) comprises a basic amount (497) and the excess gain amount (498); the excess amount (498) is transferred to the investor, thereby creating an annuity mechanism. This step can be repeated periodically to create a steady income cash flow for the investor.

Reference is made now to FIG. 5 in a preferred embodiment (600) containing a table, demonstrating the benefits of one example of the present invention over the prior art, in the case of a very fast decreasing market. In this example, the initial investment, i.e. the investor's capital (601) is $100000, the base allocation, i.e. SAFE portfolio part (603) is 80%, or $80000, the risk allocation, i.e. RISK portfolio part (605) is 20%, or $20000, the base capital period return, i.e. SAFE portfolio period return (607), which is fixed in this example, is 4% every period, e.g. annual rate, the risk capital period return, i.e. RISK portfolio period return (609), which is also fixed in this example, is −18% every period, e.g. annual rate;

In the mixed portfolio, i.e. according to prior art, the ratio between the RISK portfolio size and the total investor's capital must be kept at a fixed level, i.e. 20% in this example, similarly, the ratio between the SAFE portfolio size and the total investor's capital must be kept at a fixed level, i.e. 80%; this is done using a readjustment mechanism performed in this example by the end of every period, which transfers capital amounts between the two portfolios such that the abovementioned ratios are maintained; in the case of a deceasing market, this means transferring capital from the SAFE portfolio to the RISK portfolio at the end of each period;

In this example it can be seen that in the prior art case, the SAFE portfolio evolves from $80000 in period 0 (620), to $79680 in period 1 (621), to $79361 in period 2 (622), to $79044 in period 3 (623), to $78728 in period 4 (624); the RISK portfolio evolves from $20000 in period 0 (630), to $19920 in period 1 (631), to $79361 in period 2 (632), to $79044 in period 3 (633), to $78728 in period 4 (634); the total investor's capital evolves from $100000 in period 0 (640), to $99600 in period 1 (641), to $99202 in period 2 (642), to $98805 in period 3 (643), to $98410 in period 4 (644);

It can be noticed that in the case of a mixed portfolio (as in the prior art) each one of the SAFE portfolio size, the RISK portfolio size and the total investor's capital, change according to a geometric sequence, i.e. there is a fixed proportion between every two subsequent values. In this case the value of each of these sequences is decreasing by 0.4% every period (i.e. the geometrical sequence coefficient is 0.996); in other words, in this simple example, as time passes, the RISK portfolio, the SAFE portfolio and the investor's capital, all keep shrinking to infinity and tends to reach value of zero; this is happening although the periodical change of the SAFE portfolio is not negative.

The behavior is completely different in the case of an independently managed, separate portfolio management, as is described in the present invention; in this example, demonstrated in this preferred embodiment, the ratio between the RISK portfolio size and the, total investor's capital or between the SAFE portfolio size and the total investor's capital does not have to be kept at a fixed level;

Thus, part of the RISK portfolio out of the investor's capital, in the case of a decreasing market, is also decreasing, assuming the SAFE portfolio is not decreasing faster than the RISK portfolio; Similarly, in the case of a decreasing market and assuming the SAFE portfolio is not decreasing faster than the RISK portfolio, the size of the SAFE portfolio is taking increasingly bigger part of the investor's capital; no capital is transferred from the SAFE portfolio to the RISK portfolio at the end of each period;

In this example it can be seen that in the independently managed, separate portfolio management case, in this example of the present invention, the SAFE portfolio evolves from $80000 in period 0 (660), to $83200 in period 1 (661), to $86528 in period 2 (662), to $89989 in period 3 (663), to $93589 in period 4 (664); the RISK portfolio evolves from $20000 in period 0 (670), to $16400 in period 1 (671), to $13448 in period 2 (672), to $11027 in period 3 (673), to $9042 in period 4 (674); the total investor's capital evolves from $100000 in period 0 (680), to $99600 in period 1 (681), to $99976 in period 2 (682), to $101016 in period 3 (683), to $102631 in period 4 (684);

Thus, in the independently managed portfolio, the SAFE portfolio is increasing in size and the RISK portfolio is fast decreasing in size, hence the SAFE portfolio is taking bigger and bigger part of the investor's capital and the RISK portfolio is taking smaller and smaller part of the investor's portfolio. In the long run, in case of a fast decreasing market, the SAFE portfolio shall keep growing and the RISK portfolio will be very small, thereby limiting the risk to the investor.

This effect is defined in the present invention as “loss deceleration”, i.e. the rate of the decreasing rate of the gain or the second derivative of the gain, is limited, thereby limiting the potential loss to the initial size of the RISK portfolio.

This risk limit does not exist in the prior art, as was seen above, where the total investor's capital would go down to zero at the long run.

Moreover, this example shows that even in conditions of a fast decreasing market, the total investor's capital can grow; here the total investor's capital that initially decreased from $100000 in period 0 (680) down to $99600 in period 1 (681), then started growing back to $99976 in period 2 (682), to $101016 in period 3 (683), and to $102631 in period 4 (684); thus covering the initial losses, and even growing to a figure that is higher than the initial investment, i.e. more than $100000.

Additionally, the total investor's capital in the separately managed portfolio is always bigger than or equal to the total investor's capital in the mixed portfolios case. This is true for both increasing and decreasing markets, and for any period rate change of the RISK portfolio, for any period rate change of the SAFE portfolio, and for any allocation of the investor's capital between the SAFE portfolio and the RISK portfolio.

The general mathematical representation for the behavior of a mixed portfolio (prior art) is:

Let Aᵢ be the investor's capital at period i, hence A₀ would be the initial investor's capital;

Let P_{R} be the initial part of the RISK portfolio from the initial investor's capital (in this mixed portfolio case, this is also true for every successive period); 0≦P_{R}≦1

In this sample the SAFE portfolio size takes up the remainder of the investor's capital, hence P_{S}(1−P_{R}) would represent the initial part of the SAFE portfolio from the initial investor's capital (in this mixed portfolio case, this is also true for every successive period); 0≦(1−P_{R})—1;

Let r_{R} be the periodical change of the RISK portfolio and let us assume, for simplicity reasons, that this change is fixed every period, in this example; 0≦r_{R}≦1

Let r_{S} be the periodical change of the SAFE portfolio and let us assume, for simplicity reasons, that this change is fixed every period, in this example; 0≦r_{S}≦1

Let Rᵢ be the size of the RISK portfolio at period i; and let Sᵢ be the size of the SAFE portfolio at period i; hence

Aᵢ=Rᵢ+Sᵢ (1

R₀=P_{R}A₀ (2)

S₀=(1−P_{R})A₀ (3)

Now, the mathematical equation for the RISK portfolio size at period (i+1) relative to its size at period i is, in the mixed portfolio case:

Rᵢ₊₁=[P_{R}(1+r_{R})+(1−P_{R})(1+r_{S})]Rᵢ (4)

Similarly, the mathematical equation for the SAFE portfolio size at period (i+1) relative to its size at period i is, in the mixed portfolio case:

Sᵢ₊₁=[P_{R}(1+r_{R})+(1−P_{R})(1+r_{S})]Sᵢ (5)

From (1), (4) and (5), we get that the mathematical equation for the investor's capital size at period (i+1) relative to its size at period i is, in the mixed portfolio case:

Aᵢ₊₁[P_{R}(1+r_{R})+(1−P_{R})(1+r_{S})]Aᵢ (6)

The coefficient [P_{R}(1+r_{R})+(1−P_{R})(1+r_{S})] is fixed, therefore Aᵢ, Rᵢ and Sᵢ are geometrical sequences, and their general presentation is:

Rᵢ=[P_{R}(1+r_{R})+(1−P_{R})(1+r_{S})]ⁱR₀ (7)

Similarly, the mathematical equation for the SAFE portfolio size at period (i+1) relative to its size at period i is, in the mixed portfolio case:

Sᵢ=[P_{R}(1+r_{R})+(1−P_{R})(1+r_{S})]ⁱS₀ (8)

Again, from (1), (7) and (8), we get that the mathematical equation for the investor's capital size at period (i+1) relative to its size at period i is, in the mixed portfolio case:

Aᵢ=[P_{R}(1+r_{R})+(1−P_{R})(1+r_{S})]ⁱA₀ (9)

Let us mark this coefficient by the letter C, then:

C≡[P_{R}(1+r_{R})+(1−P_{R})(1+r_{l )]} (10)

Each of the geometrical sequences Aᵢ, Rᵢ and Sᵢ is asymptotically decreasing to zero when the coefficient C is positive and smaller than 1, this happens when:

$$- {r}_{R} > \frac{( 1 - {p}_{R} )}{{p}_{R}} {r}_{S}$$

In other words, if the periodical rate of the decreasing change of the RISK portfolio is bigger than

$$\frac{( 1 - {p}_{R} )}{{p}_{R}}$$

times the rate of the non-decreasing change of the SAFE portfolio, than the investor's capital and each of its two comprising portfolios (the RISK portfolio and the SAFE portfolio), would eventually go to zero.

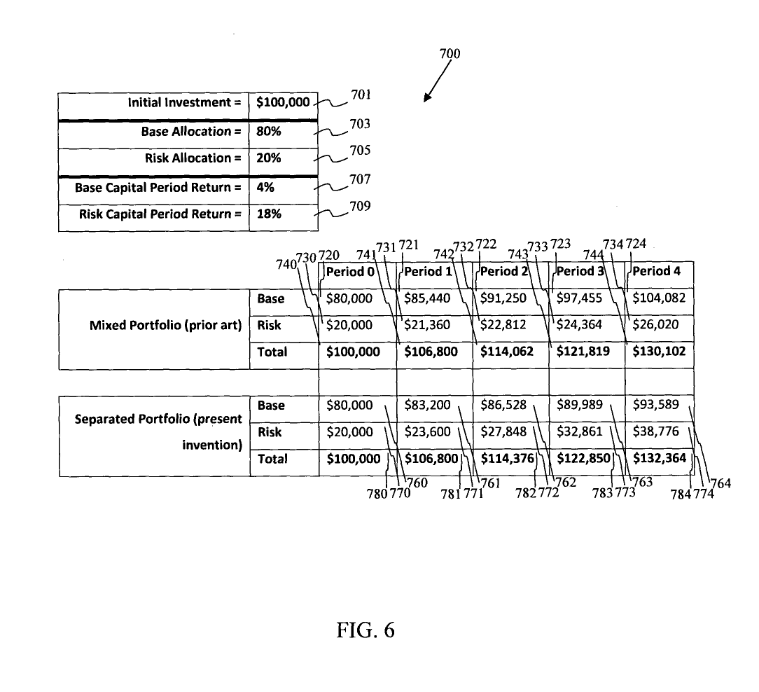

In the example given in FIG. 6, r_{R} is (−18%), r_{S} is (4%), P_{R} is (20%), P_{S}=(1−P_{R}) is (80%), therefore

$$- {r}_{R} = 18 \% > 16 \% = 4 * 4 \% = \frac{80 \%}{20 \%} 4 \% = \frac{( 1 - {p}_{R} )}{{p}_{R}} {r}_{S} •$$

Equations (7), (8), (9) and (10) can be applied, also for the case of an increasing market, i.e. positive r_{R} and r_{S}.

For the independently managed, separate portfolio management, as is described in the present invention, in this example, the mathematical equation is:

Bᵢ=[P_{R}(1+r_{R})ⁱ+(1−P_{S})(1+r_{S})ⁱ]A₀ (12)

where Bᵢ is the total investor's capital in the case of the separately managed portfolios. Mathematically, the expression (12) for the total investor's capital in the separately managed portfolios case is always bigger than the expression (9), for the total investor's capital in the mixed portfolios case; and this is true for both increasing and decreasing markets, and for any period rate change of the RISK portfolio, for any period rate change of the SAFE portfolio, and for any allocation of the investor's capital between the SAFE portfolio and the RISK portfolio.

Reference is made now to FIG. 6 in a preferred embodiment (700) containing a table, demonstrating the benefits of one example of the present invention over the prior art, in the case of a fast increasing market. In this example, the initial investment, i.e. the investor's capital (701) is $100000, the base allocation, i.e. SAFE portfolio part (703) is 80%, or $80000, the risk allocation, i.e. RISK portfolio part (705) is 20%, or $20000, the base capital period return, i.e. SAFE portfolio period return (707), which is fixed in this example, is 4% every period, e.g. annual rate, the risk capital period return, i.e. RISK portfolio period return (709), which is also fixed in this example, is 18% every period, e.g. annual rate;

In the mixed portfolio, i.e. according to prior art, the ratio between the RISK portfolio size and the total investor's capital must be kept at a fixed level, i.e. 20% in this example, similarly, the ratio between the SAFE portfolio size and the total investor's capital must be kept at a fixed level, i.e. 80%; this is done using a readjustment mechanism performed in this example by the end of every period, which transfers capital amounts between the two portfolios such that the abovementioned ratios are maintained; in the case of an increasing market, this means transferring capital from the RISK portfolio to the SAFE portfolio at the end of each period;

In this example it can be seen that in the prior art case, the SAFE portfolio evolves from $80000 in period 0 (720), to $85440 in period 1 (721), to $91250 in period 2 (722), to $97455 in period 3 (723), to $104082 in period 4 (724); the RISK portfolio evolves from $20000 in period 0 (730), to $21360 in period 1 (731), to $22812 in period 2 (732), to $24364 in period 3 (733), to $26020 in period 4 (734); the total investor's capital evolves from $100000 in period 0 (740), to $106800 in period 1 (741), to $114062 in period 2 (742), to $121819 in period 3 (743), to $130102 in period 4 (744);

The behavior is completely different in the case of an independently managed, separate portfolio management, as is described in the present invention; in this example, demonstrated in this preferred embodiment, the ratio between the RISK portfolio size and the total investor's capital or between the SAFE portfolio size and the total investor's capital does not have to be kept at a fixed level;

Thus, part of the RISK portfolio out of the investor's capital, in the case of an increasing market, is also increasing, assuming the SAFE portfolio is not increasing faster than the RISK portfolio; Similarly, in the, case of an increasing market and assuming the SAFE portfolio is not increasing faster than the RISK portfolio, the size of the SAFE portfolio is taking decreasingly smaller part of the investor's capital; no capital is transferred from the RISK portfolio to the SAFE portfolio at the end of each period;

In this example it can be seen that in the independently managed, separate portfolio management case, in this example of the present invention, the SAFE portfolio evolves from $80000 in period 0 (760), to $83200 in period 1 (761), to $86528 in period 2 (762), to $89989 in period 3 (763), to $93589 in period 4 (764); the RISK portfolio evolves from $20000 in period 0 (770), to $23600 in period 1 (771), to $27848 in period 2 (772), to $32861 in period 3 (773), to $38776 in period 4 (774); the total investor's capital evolves from $100000 in period 0 (780), to $106800 in period 1 (781), to $114376 in period 2 (782), to $122850 in period 3 (783), to $132364 in period 4 (784);

Thus, in the independently managed portfolio, the SAFE portfolio is decreasing in size and the RISK portfolio is increasing in size, hence the SAFE portfolio is taking smaller and smaller part of the investor's capital and the RISK portfolio is taking bigger and bigger part of the investor's portfolio.

This effect is defined in the present invention as “gain acceleration”, i.e. the rate of the increasing rate of the gain or the second derivative of the gain, is unlimited, thereby allowing the gain of the RISK portfolio to grow exponentially in time in conditions of an increasing market.

In the case of the mixed portfolios, as appears in prior art, tin this example, while the RISK portfolio also grows exponentially in time, its rate of growth is smaller than in the case of separately managed portfolios, because in the case of mixed portfolios capital is being transferred from the RISK portfolio to the SAFE portfolio by the end of each period.

Additionally, as was also shown in FIG. 5, the total investor's capital in the separately managed portfolio is always bigger than or equal to the total investor's capital in the mixed portfolios case. This is true for both increasing and decreasing markets, and for any period rate change of the RISK portfolio, for any period rate change of the SAFE portfolio, and for any allocation of the investor's capital between the SAFE portfolio and the RISK portfolio.

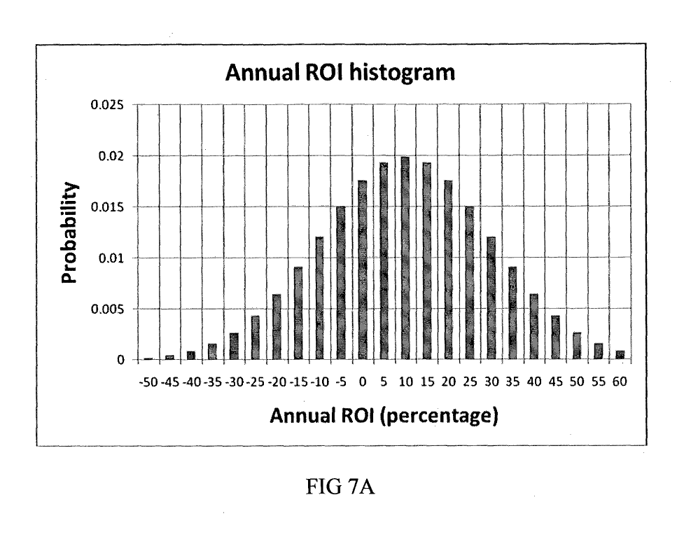

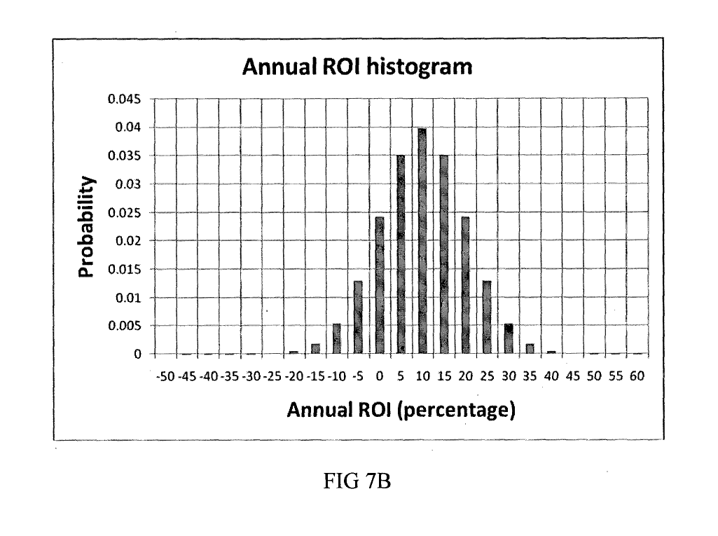

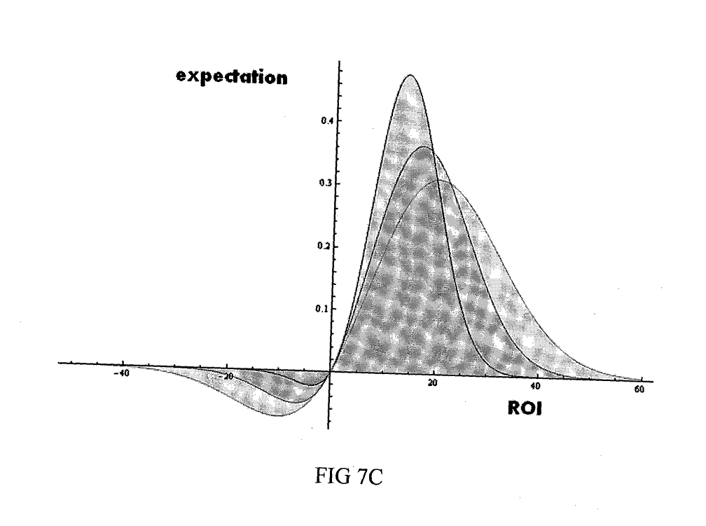

With reference to FIGS. 7A-C we further illustrate the utility of the current invention. The expected ROI of a given investment in the overwhelming majority of cases takes the form of a Gaussian or bell-shaped curve. There is some ‘expected return’ such as 10% annual ROI, but other returns are also possible. Those that are closer to 10% are more likely, while those that are further away are less likely. Thus a histogram may be formed as in FIG. 7, which shows the annual ROI on the x-axis and the probability of this ROI occurring on the y-axis. The average ROI expected for the particular investment shown in FIG. 7A is 10%, while the standard deviation (a measure of the spread or wideness of the histogram) is 20%.

In FIG. 7B a second histogram is shown which has an average expected ROI of 10% but a standard deviation (spread) of only 10%. Thus the probability of losing money (negative ROI) is less, and the probability of very high returns is also less. This is therefore in a sense a safer investment than that shown in FIG. 7A; the ‘risk’ is quantified by the standard deviation. Many investors would automatically choose the investment represented by FIG. 7B over that represented by FIG. 7A, due to the lower risk involved. However the actual average return on investment is in fact the same as for the case of FIG. 7A! This may be calculated as follows. The Gaussian takes the mathematical form

$$p ( x ) = \frac{1}{σ \sqrt{2 π}} exp ( - \frac{{( x - μ )}^{2}}{2 {σ}^{2}} )$$

The average value of a variable such as the ROI, which follows a Gaussian distribution, is the integral of the value times its probability:

$$\begin{matrix}〈 x 〉 = {\int }_{- ∞}^{∞} z \frac{1}{σ \sqrt{2 π}} exp ( - \frac{{( z - μ )}^{2}}{2 {σ}^{2}} ) d z \\ = \frac{1}{σ \sqrt{2 π}} ( - {σ}^{2} exp ( - \frac{{( z - μ )}^{2}}{2 {σ}^{2}} ) - μσ \sqrt{\frac{π}{2}} Erf ( \frac{μ - z}{\sqrt{2} σ} ) ) {\vert}_{- ∞}^{∞} \\ = μ\end{matrix}$$

The function

$$\frac{z}{σ \sqrt{2 π}} exp ( - \frac{{( z - μ )}^{2}}{2 {σ}^{2}} )$$

is shown in 7C for μ=10 and σ=10,15,20—as the value of σ increases, the plot grows and shifts right, but the overall expectation value remains constant in keeping with the result above that [symbol] x [symbol] =μ.

One can construct a ‘risk of loss’ measure by integrating over all the region of negative ROI:

$$\begin{matrix}r = - {\int }_{- ∞}^{0} \frac{z}{σ \sqrt{2 π}} exp ( - \frac{{( z - μ )}^{2}}{2 {σ}^{2}} ) d z \\ = \frac{σ}{\sqrt{2 π}} exp ( - \frac{{μ}^{2}}{2 {σ}^{2}} ) + \frac{1}{2} μ Erf ( \frac{μ}{σ \sqrt{2}} ) - \frac{μ}{2}\end{matrix}$$

This represents the possible loss due to the risk of the investment, and will take larger and larger values, for larger and larger losses.

The assessment of risk of an entire portfolio or group of investments can be assessed by summing over individual risks, weighted by investment amounts:

$$〈 σ 〉 = {\sum }_{i} {p}_{i} {σ}_{i}$$

where σᵢ is the standard deviation of the ith investment in the portfolio, and pᵢ is the fraction of total investment in the ith investment. Analogously an overall risk of loss can be defined as

$$r = {\sum }_{i} {p}_{i} {r}_{i}$$

The crux of the invention is to match the measure of risk in an investment portfolio to the risk tolerance of the individual investor. Thus the deviation between desired and actual risk, as defined by any of the measures above, is minimized by the current invention.

This may be accomplished in practice by measuring the investor's risk tolerance t by means such as the Risk Tolerance Score, the State-Trait Anxiety Inventory (STAI), the Yale Preoperative Anxiety Scale (mYPAS), and the Wong-Baker FACES scale. The score provided by one or more of these tests are combined and normalized to reach the risk tolerance t, which is then compared to the actual risk. Investments are chosen such that some measure of the difference between t and r is minimized, for instance by minimizing |t−r|, (t−r)², or monotonic combinations thereof.

1-59. (canceled)

60. A method for reducing investor's anxiety, comprising steps of:
a. providing a SAFE portfolio investment anxiety scale card (IASC) and a RISK portfolio IASC;
b. assessing investor's anxiety value by implementing said SAFE portfolio IASC and said RISK portfolio IASC, on said investor;
c. allocating said investor's capital initially into:
i. a managed SAFE portfolio having a first predetermined initial size comprising at least one subset of SAFE portfolios;
ii. a managed RISK portfolio having a second predetermined initial size comprising at least one subset of RISK portfolios;
d. determining range values for said two portfolios, comprising steps of:
i. determining minimal allowed SAFE value, maximal allowed SAFE value and optimal SAFE value for said managed SAFE portfolio, according to predetermined statistical data, such that said optimal SAFE value is larger than said minimal allowed SAFE value and smaller than said maximal allowed SAFE value;
ii. determining minimal allowed RISK value, maximal allowed RISK value and optimal RISK value for said managed RISK portfolio, according to predetermined statistical data, such that said optimal RISK value is larger than said minimal allowed RISK value and smaller than said maximal allowed RISK value;
e. calibrating said two IASC cards, comprising steps of:
i. marking said minimal allowed SAFE value, said maximal allowed SAFE value and said optimal SAFE value of said SAFE portfolio IASC;
ii. marking said minimal allowed RISK value, said maximal allowed RISK value and said optimal RISK value of said RISK portfolio IASC;
f. adjusting allocation size of said two portfolios, comprising steps of:
i. adjusting size of said SAFE portfolio, such that said investor's anxiety value is substantially equal to said optimal SAFE value, is larger than said minimal allowed SAFE value and is smaller than said maximal allowed SAFE value;
ii. adjusting size of said RISK portfolio, such that said investor's anxiety value is substantially equal to said optimal RISK value, is larger than said minimal allowed RISK value and is smaller than said maximal allowed RISK value;
iii. reassessing said investor's anxiety value by implementing said SAFE portfolio IASC and said RISK portfolio IASC, on said investor;
iv. repeating steps (i) to (iii), until investor's anxiety value is within permitted range for said two portfolios;
g. managing said investor's capital in said two portfolios; and
h. withdrawing at least part of said investor's capital from at least one of said portfolios;
wherein said step of managing is performed independently for each of said two portfolios, such that said two portfolios are isolated from one another.

61. The method according to claim 60, additionally comprising:
readjusting allocation size of said two portfolios, comprising steps of:
i. adjusting size of said SAFE portfolio, such that said investor's anxiety value is substantially equal to said optimal SAFE value, is larger than said minimal allowed SAFE value and smaller than said maximal allowed SAFE value;
ii. adjusting size of said RISK portfolio, such that said investor's anxiety value is substantially equal to said optimal RISK value, is larger than said minimal allowed RISK value and smaller than said maximal allowed RISK value;
iii. reassessing said investor's anxiety value by implementing said SAFE portfolio IASC and said RISK portfolio IASC, on said investor; and
iv. repeating steps (a) to (c), until investor's anxiety value is within permitted range for said two portfolios; said additional step is performed at a predetermined interval subsequent to the time at which said investor's capital was initially allocated.

62. The method according to claim 60, wherein said step of managing said investor's capital in said two portfolios is performed using Optimal Portfolio Model according to commonly acceptable standards, such that an optimal portfolio composition is obtained in each of said two portfolios, further wherein said method comprises at least one of the following step; managing using an external brokerage firm, assessing said investor's anxiety value using a Reverse Financial Engineering (RFE) model.

63. The method according to claim 60, additionally comprising at least one step of;
managing said investor's capital in said SAFE portfolio with substantially below average volatility, such that the capital preservation of said SAFE portfolio is achieved, managing said investor's capital in said RISK portfolio with substantially above average volatility, such that the capital appreciation of said RISK portfolio is achieved., evaluating the performance of each of said two portfolios, by means of comparing said performances to well-known benchmarks according to accepted standards; reporting said performances to said investor, managing said RISK portfolio such that gain acceleration is achieved during bull market periods, managing said RISK portfolio, such that loss deceleration is achieved during bear market periods, managing said two portfolios using periodically charged management fees as a fixed percentage of each of said two portfolio size, managing said SAFE portfolio using reduced management fees compared to the management fees of said RISK portfolio.

64. The method according to claim 60, additionally comprising at least one of the following steps; transferring capital from said RISK portfolio to said SAFE portfolio, at periods and amounts under said investor's discretion, such that the ratio between said RISK portfolio size and said investor's capital is reduced, periodically withdrawing capital from said SAFE portfolio, by means of a predetermined annuity mechanism, such that a steady income cash flow for said investor is obtained, managing a second set of two mixed portfolios, characterized by the same initial size as said isolated portfolios, wherein the total amount of said investor's capital in any given time within said isolated portfolios is bigger than the total amount of said investor's capital within said mixed portfolios.

65. A computer implemented method for reducing investor's anxiety, comprising steps of:
a. assessing the personal financial risk tolerance (PFRT) of said investor by operating a computer implemented survey of financial risk tolerance (SOFRT) calculator for calculating said PFRT of said investor;
b. allocating said investor's capital into:
i. a managed SAFE portfolio comprising at least one subset of SAFE portfolios, said managed SAFE portfolio characterized by a size, such that the ratio between said size of said managed SAFE portfolio to investor's capital is inversely proportional to said investor score on said PFRT; and
ii. a managed RISK portfolio comprising at least one subset of RISK portfolios, said managed RISK portfolio characterized by a size which is the remainder of said investor's capital after allocating said managed SAFE portfolio; and
c. managing said investor's capital in said two portfolios;
wherein said step of managing is performed independently for each of said two portfolios, such that said two portfolios are isolated from one another.

66. The method according to claim 65, additionally comprising steps of: a. reassessing said PFRT of said investor by operating said SOFRT calculator for calculating said PFRT of said investor; and b. transferring part of said investor's capital between said two portfolios, such that after said step of transferring, the ratio between the size of said managed SAFE portfolio to said investor's capital is inversely proportional to said investor reassessed PFRT and the size of said managed RISK portfolio is the remainder of said investor's capital; said additional steps of reassessing (a) and of transferring (b) are performed at a predetermined interval subsequent to the time at which said investor's capital was initially allocated further comprising at least one step of managing said investor's capital in said two portfolios is performed using Optimal Portfolio Model according to commonly acceptable standards, such that an optimal portfolio composition is obtained in each of said two portfolios managing is performed using an external brokerage firm assessing said PFRT using a Reverse Financial Engineering (RFE) model, managing said investor's capital in said SAFE portfolio with substantially below average volatility, such that the capital preservation of said SAFE portfolio is achieved, managing said investor's capital in said RISK portfolio with substantially above average volatility, such that the capital appreciation of said RISK portfolio is achieved, evaluating the performance of each of said two portfolios, by means of comparing said performances to well-known benchmarks according to accepted standards, reporting said performances to said investor, managing said RISK portfolio, such that gain acceleration is achieved during bull market periods, managing said RISK portfolio, such that loss deceleration is achieved during bear market periods, managing said two portfolios using periodically charged management fees as a fixed percentage of each of said two portfolio size, managing said SAFE portfolio using reduced management fees compared to the management fees of said RISK portfolio, transferring capital from said RISK portfolio to said SAFE portfolio, at periods and amounts under said investor's discretion, such that the ratio between said RISK portfolio size and said investor's capital is reduced, periodically withdrawing capital from said SAFE portfolio, by means of a predetermined annuity mechanism, such that a steady income cash flow for said investor is obtained.

67. A computer-readable medium having computer-executable instructions for performing a method for reducing investor's anxiety, the method comprising steps of:
a. assessing the personal financial risk tolerance (PFRT) of said investor by operating a computer implemented survey of financial risk tolerance (SOFRT) calculator for calculating said PFRT of said investor;
b. allocating said investor's capital into:
i. a managed SAFE portfolio, characterized by a size such that the ratio between said size of said managed SAFE portfolio to investor's capital is inversely proportional to said investor score on said PFRT;
ii. a managed RISK portfolio, characterized by a size which is the remainder of said investor's capital after allocating said managed SAFE portfolio; and
c. managing said investor's capital in said two portfolios;
wherein said step of managing is performed independently for each of said two portfolios, such that said two portfolios are isolated from one another.

68. The computer-readable medium, according to claim 67, wherein at least one of the following is true;
the computer readable medium has computer-executable instructions for performing said method for reducing said investor's anxiety said method additionally comprising steps of:
a. reassessing said PFRT of said investor by operating said SOFRT calculator for calculating said PFRT of said investor; and
b. transferring part of said investor's capital between said two portfolios, such that after said step of transferring, the ratio between the size of said managed SAFE portfolio to said investor's capital is inversely proportional to said investor reassessed PFRT and the size of said managed RISK portfolio is the remainder of said investor's capital;
said additional steps of reassessing (a) and of transferring (b) are performed at a predetermined interval subsequent to the time at which said investor's capital was initially allocated;
the computer-readable medium has computer-executable instructions for performing said method for reducing said investor's anxiety wherein said step of managing said investor's capital in said two portfolios, in said method, is performed using Optimal Portfolio Model according to commonly acceptable standards, such that an optimal portfolio composition is obtained in each of said two portfolios;
the computer-readable medium has computer-executable instructions for performing said method for reducing said investor's anxiety, wherein said step of managing, in said method, is performed using an external brokerage firm;
the computer-readable medium has computer-executable instructions for performing said method for reducing said investor's anxiety, said method additionally comprising step of assessing said PFRT using a Reverse Financial Engineering (RFE) model;
the computer-readable medium has computer-executable instructions for performing said method for reducing said investor's anxiety, said method additionally comprising step of managing said investor's capital in said SAFE portfolio with substantially below average volatility, such that the capital preservation of said SAFE portfolio is achieved. the computer-readable medium has computer-executable instructions for performing said method for reducing said investor's anxiety, said method additionally comprising step of managing said investor's capital in said RISK portfolio with substantially above average volatility, such that the capital appreciation of said RISK portfolio is achieved. the computer-readable medium has computer-executable instructions for performing said method for reducing said investor's anxiety, said method additionally comprising step of evaluating the performance of each of said two portfolios, by means of comparing said performances to well-known benchmarks according to accepted standards;
the computer-readable medium has computer-executable instructions for performing said method for reducing said investor's anxiety, said method additionally comprising step of reporting said performances to said investor;
the computer-readable medium has computer-executable instructions for performing said method for reducing said investor's anxiety, said method additionally comprising step of managing said RISK portfolio, such that gain acceleration is achieved during bull market periods, the computer-readable medium has computer-executable instructions for performing said method for reducing said investor's anxiety, said method additionally comprising step of managing said RISK portfolio, such that loss deceleration is achieved during bear market periods;
the computer-readable medium has computer-executable instructions for performing said method for reducing said investor's anxiety, said method additionally comprising step of managing said two portfolios using periodically charged management fees as a fixed percentage of each of said two portfolio size;
the computer-readable medium has computer-executable instructions for performing said method for reducing said investor's anxiety, said method additionally comprising step of managing said SAFE portfolio using reduced management fees compared to the management fees of said RISK portfolio, the computer-readable medium has computer-executable instructions for performing said method for reducing said investor's anxiety, said method additionally comprising a step of transferring capital from said RISK portfolio to said SAFE portfolio, at periods and amounts under said investor's discretion, such that the ratio between said RISK portfolio size and said investor's capital is reduced.

69. The computer-readable medium, according to claim 67, having computer-executable instructions for performing said method for reducing said investor's anxiety, said method additionally comprising a step of periodically withdrawing capital from said SAFE portfolio, by means of a predetermined annuity mechanism, such that a steady income cash flow for said investor is obtained.

70. A system for investment portfolio management and reduction of investor's anxiety, comprising:
a. at least one storage device;
b. at least one input means; and
c. at least one processor operable to:
i. assess the personal financial risk tolerance (PFRT) of said investor by operating a computer implemented survey of financial risk tolerance (SOFRT) calculator for calculating said PFRT of said investor; said PFRT is stored in said at least one storage device;
ii. allocate, by means of said at least one input means, said investor's capital into: a managed SAFE portfolio, characterized by a size such that the ratio between said size of said managed SAFE portfolio to investor's capital is inversely proportional to said investor score on said PFRT and a managed RISK portfolio, characterized by a size which is the remainder of said investor's capital after allocating said managed SAFE portfolio; said portfolios sizes are stored in said at least one storage device; and
iii. manage said investor's capital in said two portfolios;
wherein said management of said investor's capital in said two portfolios is performed by said at least one processor independently for each of said two portfolios, such that said two portfolios are isolated from one another or,
d. a pair of portfolio investment anxiety cards useful to reduce investor's anxiety, comprising:
e. a SAFE portfolio investment anxiety scale card (IASC) and
f. a RISK portfolio IASC;
g. mechanism to calibrate said IASCs, such that a minimal allowed SAFE value, a maximal allowed SAFE value and a optimal SAFE value are marked on said SAFE portfolio IASC; and a minimal allowed RISK value, a maximal allowed RISK value and a optimal RISK value are marked on said RISK portfolio IASC; said IASCs are used to assess investor's anxiety value of said investor thereon;
h. at least one storage device;
i. at least one input means; and
j. at least one processor operable to:
i. store said minimal allowed SAFE value, said maximal allowed SAFE value and said optimal SAFE value, marked on said SAFE portfolio IASC, in said at least one storage device; and store said minimal allowed RISK value, said maximal allowed RISK value and said optimal RISK value, marked on said RISK portfolio IASC, in said at least one storage device;
ii. allocate, by means of said at least one input means, said investor's capital into, said investor's capital initially into:
(a) a managed SAFE portfolio having a first predetermined initial size comprising at least one subset of SAFE portfolios; and
(b) a managed RISK portfolio having a second predetermined initial size comprising at least one subset of RISK portfolios;
ii. determine range values for said two portfolios;
iii. adjust allocation size of said two portfolios; and
iv. manage said investor's capital in said two portfolios;
wherein said management is performed independently for each of said two portfolios, such that said two portfolios are isolated from one another.

71. In a system for investment portfolio management and reduction of investor's anxiety comprising:
a. at least one storage device;
b. at least one input means;
c. at least one processor operable to:
i. store a minimal allowed SAFE value, a maximal allowed SAFE value and a optimal SAFE value in said at least one storage device; and store a minimal allowed RISK value, a maximal allowed RISK value and a optimal RISK value in said at least one storage device;
ii. assess investor's anxiety value of said investor on said two IASCs;
iii. allocate, by means of said at least one input means, said investor's capital into, said investor's capital initially into:
(a) a managed SAFE portfolio having a first predetermined initial size comprising at least one subset of SAFE portfolios; and
(b) a managed RISK portfolio having a second predetermined initial size comprising at least one subset of RISK portfolios;
iv. determine range values for said two portfolios;
v. adjust allocation size of said two portfolios; and
vi. manage said investor's capital in said two portfolios independently for each of said two portfolios, such that said two portfolios are isolated from one another;
d. a pair of portfolio investment anxiety cards comprising: (i) a SAFE portfolio investment anxiety scale card (IASC) and (ii) a RISK portfolio IASC;
wherein said two IASCs are calibrated, such that a minimal allowed SAFE value, a maximal allowed SAFE value and a optimal SAFE value are marked on said SAFE portfolio IASC;
and a minimal allowed RISK value, a maximal allowed RISK value and a optimal RISK value are marked on said RISK portfolio IASC; further wherein said two IASCs are used to assess investor's anxiety value of said investor thereon.

72. A method for investment tailored to an investors risk tolerance comprising steps of:
a. assessing said customer's risk tolerance t; and
b. investing in an investment portfolio comprising N investments i each of risk rᵢ; wherein a measure of the difference between t and
$$r = {\sum }_{i = 1}^{N} {p}_{i} {r}_{i}$$
is minimized.

73. The method of claim 72, wherein at least one of the following is true, said measure of said difference between t and r is selected from the group consisting of: |t−r|, (t−r)², and monotonic combinations thereof, said measure of said investment risk rᵢ in an investment having an expected future value described by a Gaussian of center μ and standard deviation σ is selected from the group consisting of: stock price standard deviation σ,
$$\frac{σ}{\sqrt{2 π}} exp ( - \frac{{μ}^{2}}{2 {σ}^{2}} ) + \frac{1}{2} μ Erf ( \frac{μ}{σ \sqrt{2}} ) - \frac{μ}{2} ,$$
monotonic functions thereof, and monotonic combinations thereof, said customer's risk tolerance t is measured by means selected from the group consisting of: the Risk Tolerance Score, the State-Trait Anxiety Inventory (STAI), the Yale Preoperative Anxiety Scale (mYPAS), the Wong-Baker FACES scale, monotonic combinations thereof, and normalizations thereof, said investor is individually assessed for euphoric gain impact, said investment portfolio selection includes a step of euphoric gain impact assessment, said investor's resources are divided by at least one Reverse Financial engineering algorithm into multiple independently pure risk type managed portfolios comprising:
a. “SAFE Cap” portfolio of “protected” conservative type assets, for funding a basic cash stream to said investor; and
b. “RISK cap” portfolio, of “high volatility” venture type assets.

74. The method according to claim 73, wherein said “SAFE Cap” portfolio is managed and determined by an algorithm which triggers appropriate action resulting in value fluctuations at a lower than average volatility.

75. The method according to claim 73, wherein said “RISK Cap” portfolio is managed and determined by an algorithm triggering appropriate action resulting in value fluctuations at a higher than average volatility.

76. The method according to claim 73, wherein a rebalancing process is undergone at certain intervals for optimizing the size and values of the “SAFE Cap” and the “RISK Cap” according to the client's lifecycle and needs and is triggered by performance and market events and influences such that:
a. when the “RISK Cap” has achieved predetermined surpluses, it feeds dividends into the “SAFE Cap” to an extent determined by said individual investor's lifecycle and needs; and
b. the “SAFE Cap” funds cash flow needs, and when it has outperformed its predetermined targets, it also contributes to the “RISK Cap” to enlarge leverage.
